(19) United States
(12) Patent Application Publication
(10) Pub. No.: US 2018/0113829 A1
(43) Pub. Date: Apr. 26, 2018

(54) ELECTRONIC APPARATUS AND COUPLING METHOD

(71) Applicant: Sony Corporation, Tokyo (JP)

(72) Inventor: Yuya Ishikawa, Tokyo (JP)

(21) Appl. No.: 15/565,532

(22) PCT Filed: May 19, 2016
(86) PCT No.: PCT/JP2016/064888

§ 371 Date: Oct. 10, 2017

(30) Foreign Application Priority Data
Jun. 1, 2015 (JP) 2015-111087

(51) Int. Cl. G06F 13/40; G06F 1/26; G06F 13/38

(52) U.S. Cl. CPC G06F 13/4022; G06F 2213/0042; G06F 13/385; G06F 1/266

(57) ABSTRACT

An electronic apparatus of the disclosure includes a line concentrator including a plurality of ports, and a controller that switches, among the plurality of ports, a host port to which an apparatus operating as a host is coupled, on a basis of a switching instruction supplied from a first apparatus coupled to the host port.

### TECHNICAL FIELD

The disclosure relates to an electronic apparatus configured to be couplable to a plurality of apparatuses, and to a coupling method used in such an electronic apparatus.

### BACKGROUND ART

Examples of an apparatus conforming to universal serial bus (USB) standard include a so-called dual role device that has a host mode and a device mode. In the host mode, the apparatus operates as a host, and in the device mode, the apparatus operates as a device. For example, PTL 1 discloses an USB apparatus controller that determines a function at a time when the dual role device is coupled, and switches the dual role device to a device or a host on the basis of the determination result.

### CITATION LIST

### Patent Literature

PTL 1: U.S. Patent Application Publication No. 2004/1088449

### SUMMARY OF INVENTION

Incidentally, an electronic apparatus is typically requested to have high convenience, and is expected to have further improvement in the convenience.

It is desirable to provide an electronic apparatus and a coupling method that make it possible to enhance convenience.

An electronic apparatus according to an embodiment of the disclosure includes a line concentrator and a controller. The line concentrator includes a plurality of ports. The controller switches, among the plurality of ports, a host port to which an apparatus operating as a host is coupled, on the basis of a switching instruction supplied from a first apparatus coupled to the host port.

A coupling method according to an embodiment of the disclosure includes receiving a switching instruction from a first apparatus that is coupled to a host port to which an apparatus operating as a host is coupled, among a plurality of ports of a line concentrator, and switching the host port on the basis of the switching instruction.

In the electronic apparatus and the coupling method according to the respective embodiments of the disclosure, among the plurality of ports of the line concentrator, the host port to which the apparatus operating as the host is coupled is switched. At this time, the host port is switched on the basis of the switching instruction supplied from the first apparatus coupled to the host port.

In the electronic apparatus and the coupling method according to the respective embodiments of the disclosure, the host port is switched on the basis of the switching instruction supplied from the first apparatus coupled to the host port. This allows for enhanced convenience. Note that effects described here are not necessarily limitative, and may include any of effects that are described herein.

### BRIEF DESCRIPTION OF DRAWINGS

FIG. 1 is a block diagram illustrating a configuration example of an electronic apparatus system to which an electronic apparatus according to an embodiment of the disclosure is applied.

FIG. 2 is a perspective view illustrating a configuration example of a USB memory illustrated in FIG. 1.

FIG. 3 is a block diagram illustrating the configuration example of the USB memory illustrated in FIG. 1.

FIG. 4A is a flowchart illustrating an operation example of the electronic apparatus system illustrated in FIG. 1.

FIG. 4B is a flowchart illustrating the operation example of the electronic apparatus system illustrated in FIG. 1.

FIG. 5A illustrates an example of a pop-up screen.

FIG. 5B illustrates another example of the pop-up screen.

FIG. 6 illustrates an example of a pop-up screen.

FIG. 7 is a sequence diagram illustrating an example of a power supply operation in the electronic apparatus system illustrated in FIG. 1.

FIG. 8A illustrates an example of a pop-up screen according to a modification example.

FIG. 8B illustrates another example of the pop-up screen according to the modification example.

FIG. 9 illustrates an example of a pop-up screen according to another modification example.

FIG. 10 is a block diagram illustrating a configuration example of a USB memory according to another modification example.

FIG. 11 is a block diagram illustrating a configuration example of a USB memory according to another modification example.

FIG. 12 is a block diagram illustrating a configuration example of a USB memory according to another modification example.

FIG. 13 is a block diagram illustrating a configuration example of a USB hub according to another modification example.

FIG. 14 is a sequence diagram illustrating an example of a power supply operation in an electronic apparatus system according to another modification example.

### DESCRIPTION OF EMBODIMENTS

Some embodiments of the disclosure are described in detail below with reference to drawings.

### Configuration Example

FIG. 1 illustrates a configuration example of an electronic apparatus system including an electronic apparatus (a USB memory 10) according to an embodiment. Note that a coupling method according to an embodiment of the disclosure is implemented by the present embodiment and is described together. The electronic apparatus system 1 includes the USB memory 10, a smartphone 20, and a personal computer 30.

The USB memory 10 holds data. In this example, the USB memory 10 is configured to be couplable to the smartphone 20 and the personal computer 30.

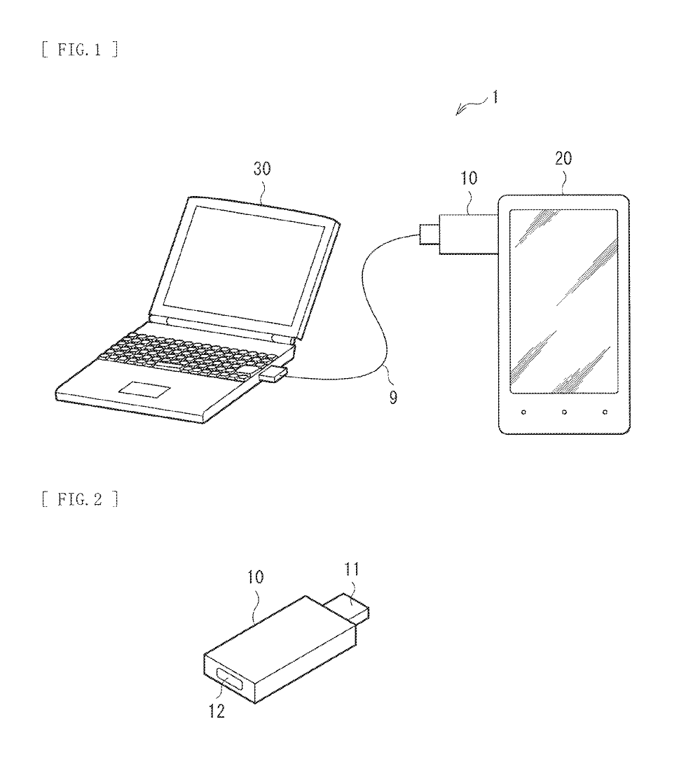

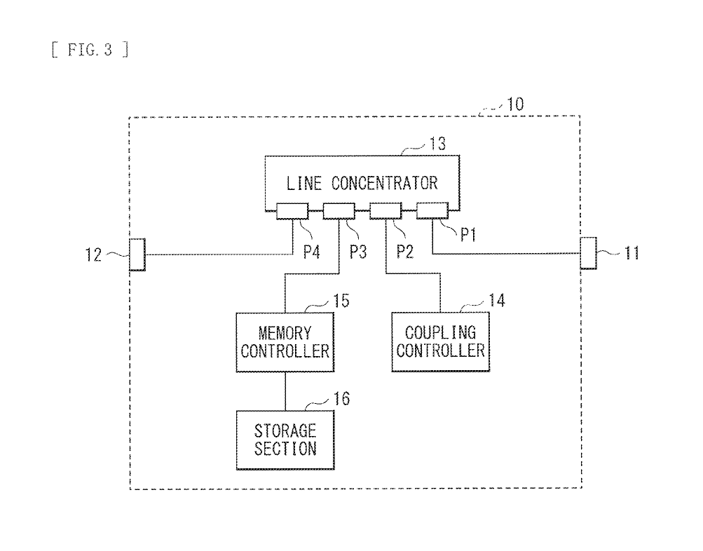

FIG. 2 illustrates an example of an outer appearance configuration of the USB memory 10. As illustrated in FIG. 2, the USB memory 10 includes a plug 11 and a receptacle 12. In this example, each of the plug 11 and the receptacle 12 is a connector conforming to a Type-C standard. In this example, the USB memory 10 is coupled to the smartphone 20 through the plug 11 and is coupled to the personal computer 30 through the receptacle 12 and a USB cable 9.

FIG. 3 illustrates a configuration example of the USB memory 10. The USB memory 10 includes a line concentrator 13, a coupling controller 14, a memory controller 15, and a storage section 16.

The line concentrator 13 is a so-called HUB, and includes four ports P1 to P4 in this example. In this example, the port P1 is coupled to the plug 11, the port P2 is coupled to the coupling controller 14, the port P3 is coupled to the memory controller 15, and the port P4 is coupled to the receptacle 12.

In the line concentrator 13, the port P1 or the port P4 functions as a so-called up facing port (UFP), and ports other than the UFP of the P1 to P4 each function as a so-called down facing port (DFP). In other words, in this example, an apparatus functioning as a host is coupled to the port P1 or the port P4. In the following, the UFP is referred to as a host port HP.

The coupling controller 14 controls coupling between the USB memory 10 and other apparatuses (in this example, the smartphone 20 and the personal computer 30). Specifically, as described later, the coupling controller 14 switches the host port HP on the basis of a switching command COM provided from the apparatus coupled to the host port HP. In this example, the coupling controller 14 is coupled to the port P2 of the line concentrator 13. The coupling controller 14 functions as a device in communication with the line concentrator 13.

The memory controller 15 controls a writing operation and a reading operation of data with respect to the storage section 16. In this example, the memory controller 15 is coupled to the port P3 of the line concentrator 13. The memory controller 15 functions as a device in communication with the line concentrator 13. The storage section 16 holds data, and is configured by a non-volatile memory. As the storage section 16, for example, a NAND flash memory may be used.

Through this configuration, in the USB memory 10, the coupling controller 14 is able to select one of the ports P1 to P4 as the host port HP, and the apparatus coupled to the host port HP is able to write data into the storage section 16 or read data stored in the storage section 16.

The smartphone 20 (FIG. 1) is a multifunctional mobile phone, and performs wireless communication with, for example, an unillustrated base station, thereby functioning as the mobile phone. The smartphone 20 includes an unillustrated USB connector (a receptacle), and is configured to be couplable to the USB memory 10 through insertion of the plug 11 of the USB memory 10 into the USB connector.

The smartphone 20 is a dual role device, and has a host mode MH and a device mode MD. The host mode MH is a mode in which the smartphone 20 functions as a host in communication between the smartphone 20 and the USB memory 10. Specifically, in the host mode MH, the smartphone 20 is able to access, for example, the storage section 16 of the USB memory 10. The device mode MD is a mode in which the smartphone 20 functions as a device in the communication between the smartphone 20 and the USB memory 10. Specifically, in the device mode MD, the smartphone 20 is accessed by, for example, the personal computer 30.

The personal computer 30 is configured to be couplable to the USB memory 10 through the USB cable 9. The personal computer 30 functions as a host in communication between the personal computer 30 and the USB memory 10. In other words, the personal computer 30 is able to access, for example, the storage section 16 of the USB memory 10.

Here, the USB memory 10 corresponds to a specific example of an “electronic apparatus” in the disclosure. The coupling controller 14 corresponds to a specific example of a “controller” in the disclosure.

### Operation and Workings

Description is given next of an operation and workings of the electronic apparatus system 1 according to the present embodiment.

### Overall Operation Outline

First, overall operation outline of the electronic apparatus system 1 is described with reference to FIGS. 1 and 3. The line concentrator 13 of the USB memory 10 couples the smartphone 20, the personal computer 30, the coupling controller 14, and the memory controller 15 to one another. The coupling controller 14 controls coupling between the USB memory 10 and other apparatuses (in this example, the smartphone 20 and the personal computer 30). The memory controller 15 controls operation of the storage section 16. The storage section 16 holds data.

### Detailed Operation

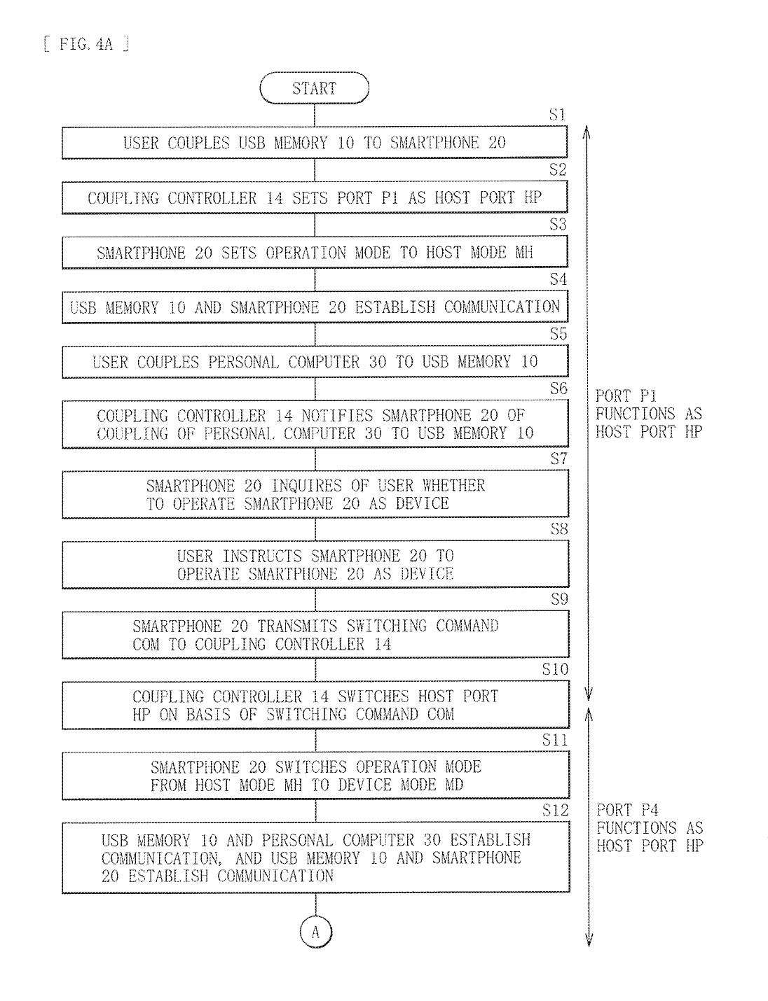

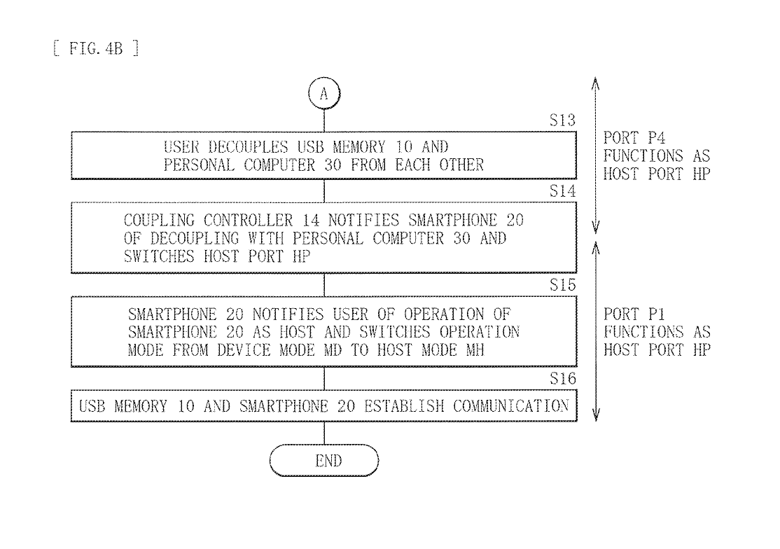

Each of FIGS. 4A and 4B is a flowchart of an operation example of the electronic apparatus system 1. In this example, a user first couples the USB memory 10 to the smartphone 20, and then couples the personal computer 30 to the USB memory 10. The operation of the coupling controller 14 at that time is described in detail.

The user first couples the USB memory 10 to the smartphone 20 (step S1).

Next, the coupling controller 14 of the USB memory 10 sets the port P1 as the host port HP (step S2). Specifically, the coupling controller 14 detects that the smartphone 20 has been coupled to the port P1 of the line concentrator 13, and sets, as the host port HP, the port P1 to which the smartphone 20 has been coupled, out of the four ports P1 to P4 of the line concentrator 13.

Next, the smartphone 20 sets the operation mode to the host mode MH (step S3). Specifically, the smartphone 20 detects the coupling of the USB memory 10, and sets the smartphone 20 to operate as a host in the communication between the USB memory 10 and the smartphone 20.

Next, the USB memory 10 and the smartphone 20 establish communication (step S4). In other words, thereafter, the smartphone 20 performs communication as a host in the communication between the USB memory 10 and the smartphone 20. This allows the smartphone 20, for example, to write data in the storage section 16 of the USB memory 10 or to read data stored in the storage section 16.

Next, the user couples the personal computer 30 to the USB memory 10 (step S5).

Next, the coupling controller 14 notifies the smartphone 20 of coupling of the personal computer 30 to the USB memory 10 (step S6). Specifically, the coupling controller 14 detects that the personal computer 30 has been coupled to the port P4 of the line concentrator 13, and notifies the smartphone 20 of the coupling.

Next, the smartphone 20 inquires of the user whether to operate the smartphone 20 as a device (step S7). Specifically, the smartphone 20 displays, for example, a pop-up screen on a display section to inquire of the user whether to operate the smartphone 20 as the device, on the basis of the notification that the personal computer 30 has been coupled to the USB memory 10.

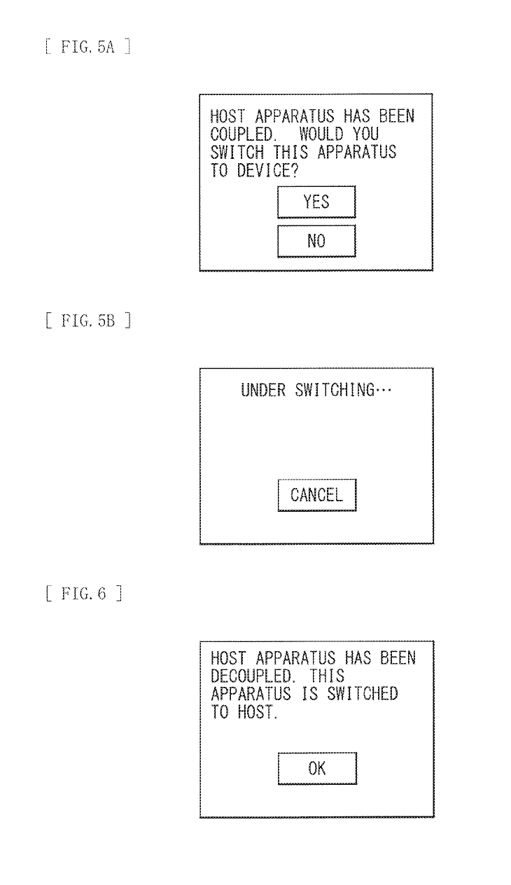

FIG. 5A illustrates an example of the pop-up screen in step S7. As illustrated, the smartphone 20 inquires whether to operate the smartphone 20 as the device. The user touches “YES” in a case of desiring to operate the smartphone 20 as the device, and touches “NO” in a case of desiring to continuously operate the smartphone 20 as the host.

Next, in this example, the user instructs the smartphone 20 to operate as the device (step S8). Specifically, the user touches “YES” on the pop-up screen as illustrated in FIG. 5A. Thereafter, the smartphone 20 displays a pop-up screen as illustrated in FIG. 5B during a period until step S12.

Next, the smartphone 20 transmits the switching command COM to the coupling controller 14 of the USB memory 10 (step S9).

Next, the coupling controller 14 switches the host port HP on the basis of the switching command COM (step S10). Specifically, the coupling controller 14 transmits a response signal ACK to the smartphone 20 and switches the host port HP from the port P1 to the port P4 to which the personal computer 30 has been coupled.

Next, the smartphone 20 switches the operation mode from the host mode MH to the device mode MD, on the basis of the response signal ACK (step S11).

Next, the USB memory 10 and the personal computer 30 establish communication, and the USB memory 10 and the smartphone 20 establish communication (step S12). In other words, thereafter the personal computer 30 performs communication as the host in the communication between the USB memory 10 and the personal computer 30, and the smartphone 20 performs communication as the device in the communication between the USB memory 10 and the smartphone 20. This allows the personal computer 30, for example, to write data in the storage section 16 of the USB memory 10 or to read data stored in the storage section 16. In addition, it is possible for the personal computer 30 to access, for example, the smartphone 20.

Next, the user removes the USB cable 9 from the USB memory 10 and the personal computer 30, thereby decoupling the USB memory 10 and the personal computer 30 from each other (step S13).

Next, the coupling controller 14 notifies the smartphone 20 of decoupling of the USB memory 10 and the personal computer 30 from each other, and switches the host port PH (step S14). Specifically, the coupling controller 14 first detects the decoupling of the USB memory 10 and the personal computer 30 from each other, and notifies the smartphone 20 of the decoupling. Thereafter, the coupling controller 14 switches the host port HP from the port P4 to the port P1 to which the smartphone 20 has been coupled.

Next, the smartphone 20 notifies the user of operation of the smartphone 20 as the host, and switches the operation mode from the device mode MD to the host mode MH (step S15). Specifically, the smartphone 20 displays, for example, a pop-up screen on the display section to notify the user of the operation of the smartphone 20 as the host, on the basis of the notification that the USB memory 10 and the personal computer 30 have been decoupled from each other.

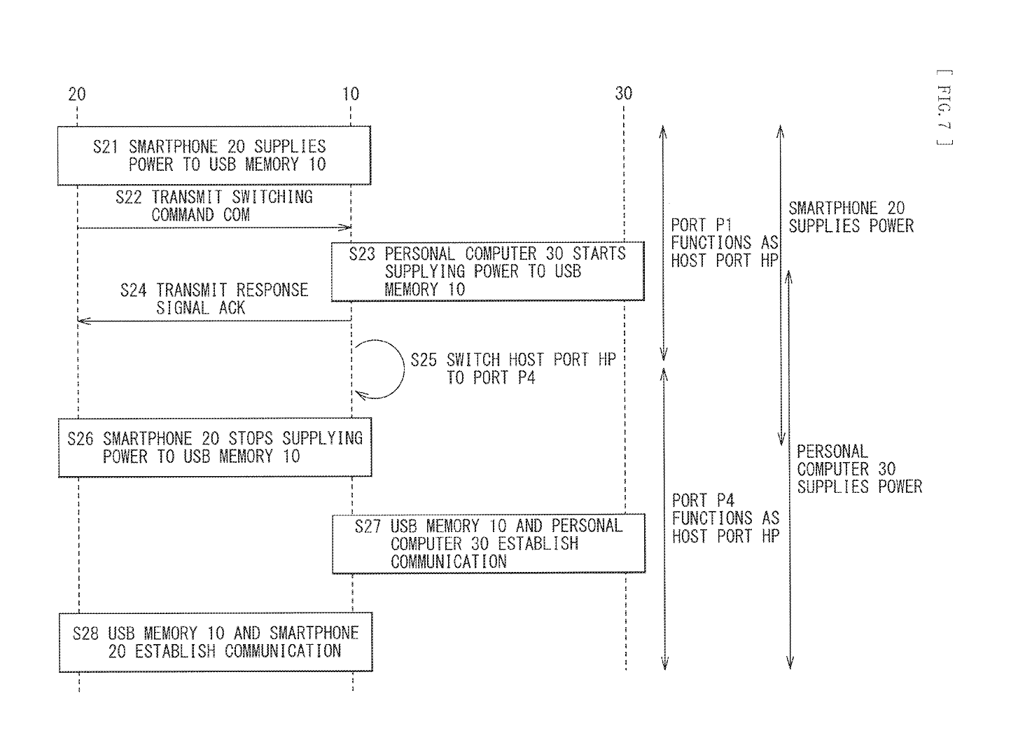

FIG. 6 illustrates an example of the pop-up screen in step S14. As illustrated, the smartphone 20 notifies the user of the operation of the smartphone 20 as the host. Thereafter, the smartphone 20 switches the operation mode from the device mode MD to the host mode MH. Thereafter, the smartphone 20 displays a pop-up screen similar to that in FIG. 5B during a period until step S16.

Next, the USB memory 10 and the smartphone 20 establish communication (step S16). In other words, thereafter, the smartphone 20 performs communication as the host in the communication between the USB memory 10 and the smartphone 20. This allows the smartphone 20, for example, to write data in the storage section 16 of the USB memory 10 or to read data stored in the storage section 16.

The flow then ends. As described above, in this example, the port P1 to which the smartphone 20 has been coupled functions as the host port HP during the period from step S1 to step S10. Further, the port P4 to which the personal computer 30 has been coupled functions as the host port HP during the period from step S10 to step S14. Furthermore, the port P1 to which the smartphone 20 has been coupled functions as the host port HP again during the period from step S14 to step S16.

Description is given next of a power supply operation in the electronic apparatus system 1 before and after the user couples the personal computer 30 to the USB memory 10 in step S5.

FIG. 7 illustrates an example of the power supply operation in the electronic apparatus system 1.

Before the user couples the personal computer 30 to the USB memory 10, the smartphone 20 supplies power to the USB memory 10 (step S21).

Thereafter, when the user couples the personal computer 30 to the USB memory 10, the smartphone 20 transmits the switching command COM to the USB memory 10 (step S22). Step S22 corresponds to step S9 in FIG. 4A.

Thereafter, the personal computer 30 starts supplying power to the USB memory 10 (step S23).

Thereafter, the USB memory 10 transmits the response signal ACK to the smartphone 20 (step S24).

Thereafter, the coupling controller 14 of the USB memory 10 switches the host port HP from the port P1 to the port P4 to which the personal computer 30 has been coupled (step S25).

Thereafter, the smartphone 20 stops supplying power to the USB memory 10 (step S26). Specifically, as illustrated in step S11 in FIG. 4A, the smartphone 20 switches the operation mode from the host mode NIH to the device mode MD, on the basis of the response signal ACK. This causes the smartphone 20 to stop supplying power.

Thereafter, the USB memory 10 and the personal computer 30 establish communication (step S27), and the USB memory 10 and the smartphone 20 establish communication (step S28). Steps S27 and S28 correspond to step S12 in FIG. 4A.

As described above, in the electronic apparatus system 1, the port P1 to which the smartphone 20 has been coupled functions as the host port HP during a period until step S25. Thereafter, the port P4 to which the personal computer 30 has been coupled functions as the host port HP during a period after step S25.

At this time, the smartphone 20 supplies power to the USB memory 10 during a period until step S26. In addition, the personal computer 30 supplies power to the USB memory 10 during a period after step S23. In other words, both of the smartphone 20 and the personal computer 30 supply power to the USB memory 10 during a period from step S23 to step S26. This allows the USB memory 10 to operate while constantly receiving supply of power, because the supply of power to the USB memory 10 is not interrupted.

Further, in the electronic apparatus system 1, the host port HP is switched, which allows for enhanced convenience. In other words, for example, in a case where the port P1 is configured to constantly function as the host port HP, it is necessary to couple the dual role device (the smartphone 20 in this example) to the port P1 when the dual role device operates as the host, and it is necessary to couple the dual role device to the port P4 when the dual role device operates as the device. In contrast, the host port HP is switched in the electronic apparatus system 1, thus making it possible to operate the dual role device as the host or as the device while allowing the dual role device to be coupled to the port P1. As described above, in the electronic apparatus system 1, it is unnecessary to perform recoupling in accordance with the operation of the dual role device, thus allowing for enhanced convenience.

Further, in the electronic apparatus system 1, the coupling controller 14 switches the host port HP on the basis of the switching command COM, thus allowing for enhanced convenience. In other words, for example, in a case where the coupling controller 14 itself is configured to perform determination and switches the host port HP, the power supply is also switched accordingly, thus resulting in possible occurrence of inconvenience in which stable power supply becomes difficult, for example. In contrast, in the electronic apparatus system 1, the coupling controller 14 switches the host port HP on the basis of the switching command COM. The switching command COM is based on a user's operation, and thus the host port HP is switched on the basis of the user's operation. As described above, in the electronic apparatus system 1, the host port HP is switched on the basis of the users operation, thus making it possible to reduce the possibility of occurrence of inconvenience, which allows for enhanced convenience.

### Effects

As described above, in the present embodiment, the host port is switched, therefore making it unnecessary to perform recoupling in accordance with the operation of the dual role device, thus allowing for enhanced convenience.

In the present embodiment, the host port HP is switched on the basis of the switching command. Therefore, the host port is switched on the basis of the user's operation, thus allowing for enhanced convenience.

### Modification Example 1

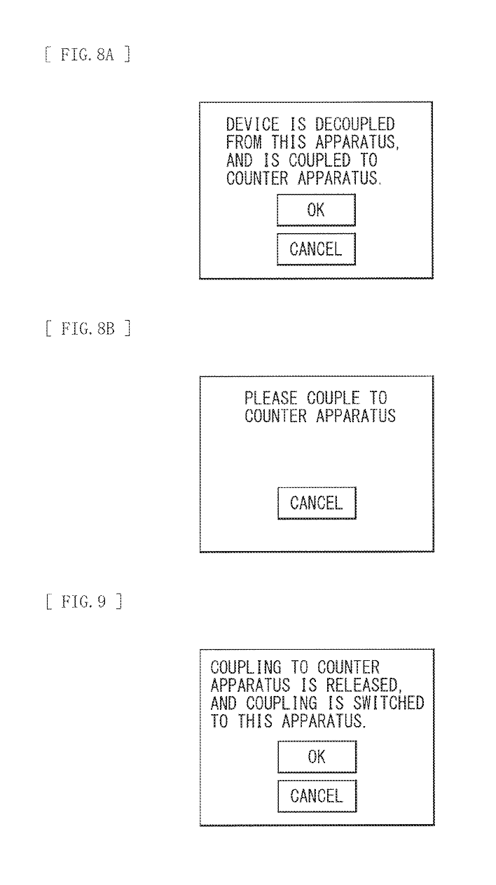

In the above-described embodiment, the smartphone 20 inquires of the user whether to operate the smartphone 20 as the device in step S7 after the user couples the personal computer 30 to the USB memory 10 in step S5; however, the operation is not limited thereto. For example, the user may couple the personal computer 30 to the USB memory 10 after the user operates the smartphone 20 to make an input to the effect that the user intends to couple the personal computer 30 to the USB memory 10. Specifically, the smartphone 20 executes software on the basis of the user's operation, and displays, for example, a pop-up screen illustrated in FIG. 8A. Thereafter, when the user touches “OK”, the smartphone 20 displays, for example, a pop-up screen illustrated in FIG. 8B, thereby prompting the user to couple the USB memory 10 to the personal computer 30 (a counter apparatus). The user couples the USB memory 10 to the personal computer 30 in response to an instruction of the pop-up screen.

### Modification Example 2

In the above-described embodiment, the smartphone 20 notifies the user of the operation of the smartphone 20 as the host in step S15 after the user decouples the USB memory 10 and the personal computer 30 from each other in step S13; however, the operation is not limited thereto. For example, the user may operate the smartphone 20 to cause the smartphone 20 to operate as the host while keeping the USB memory 10 and the personal computer 30 coupled to each other. Specifically, the smartphone 20 executes software on the basis of the user's operation, and displays, for example, a pop-up screen illustrated in FIG. 9. Thereafter, when the user touches “OK”, the smartphone 20 transmits the switching command COM to the USB memory 10, and the coupling controller 14 of the USB memory 10 switches the host port HP from the port P4 to the port P1 to which the smartphone 20 has been coupled, on the basis of the switching command COM. Thereafter, the smartphone 20 switches the operation mode from the device mode MD to the host mode MH. This allows the smartphone 20 to operate as the host.

### Modification Example 3

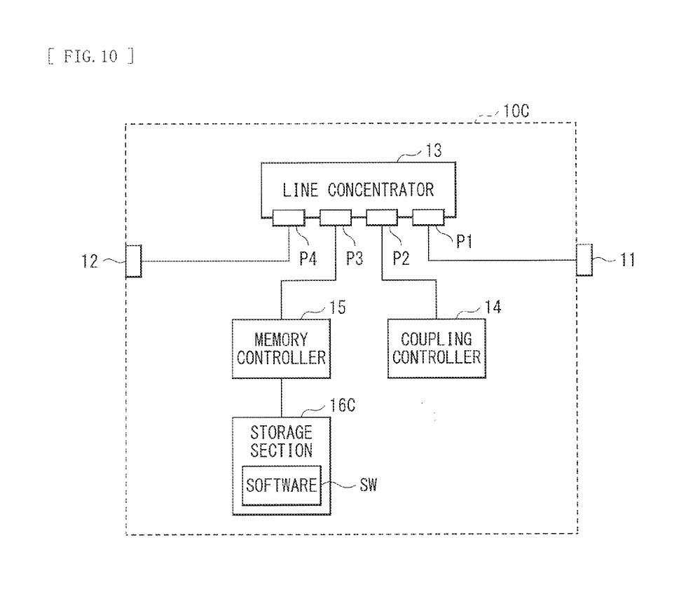

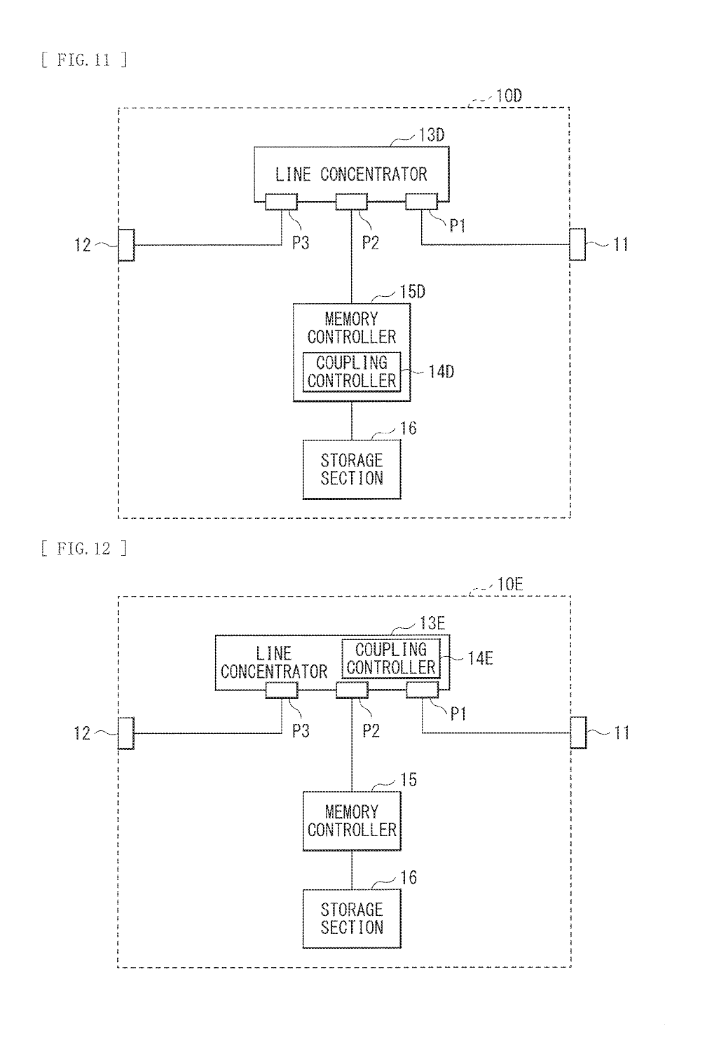

In the above-described embodiment, the pop-up screen as illustrated in FIG. 5A, 5B, or 6 is displayed on the display section of the smartphone 20. Alternatively, for example, the user may install, in the smartphone 20, software SW that displays such a pop-up screen. At this time, for example, as in a USB memory 10C illustrated in FIG. 10, the software SW may be previously stored in a storage section 16C. In this case, for example, the software SW may be installed in the smartphone 20 when the user couples the smartphone 20 to the USB memory 10 for the first time. Moreover, for example, information relating to a uniform resource locator (URL) of a server for download of the software SW may be stored in the storage section 16C. In this case, for example, the USB memory 10 notifies the smartphone 20 of the information relating to the URL to prompt the user to install the software SW when the user couples the smartphone 20 to the USB memory 10 for the first time. Furthermore, a manufacturer of the smartphone 20 may previously install the software SW in the smartphone 20.

### Modification Example 4

In the above-described embodiment, as illustrated in FIG. 3, the coupling controller 14 of the USB memory 10 is coupled to the line concentrator 13; however, the configuration is not limited thereto. For example, as in a USB memory 10D illustrated in FIG. 11, the memory controller may also have a function of the coupling controller. The USB memory IOD includes a line concentrator 13D and a memory controller 15D. The line concentrator 13D includes three ports P1 to P3. The memory controller 15D includes a coupling controller 14D. The memory controller 15D is coupled to the port P2 of the line concentrator 13D. In addition, for example, as in a USB memory 10E illustrated in FIG. 12, the line concentrator may also have a function of the coupling controller. The USB memory 10E includes a line concentrator 13E. The line concentrator 13E includes a coupling controller 14E.

### Modification Example 5

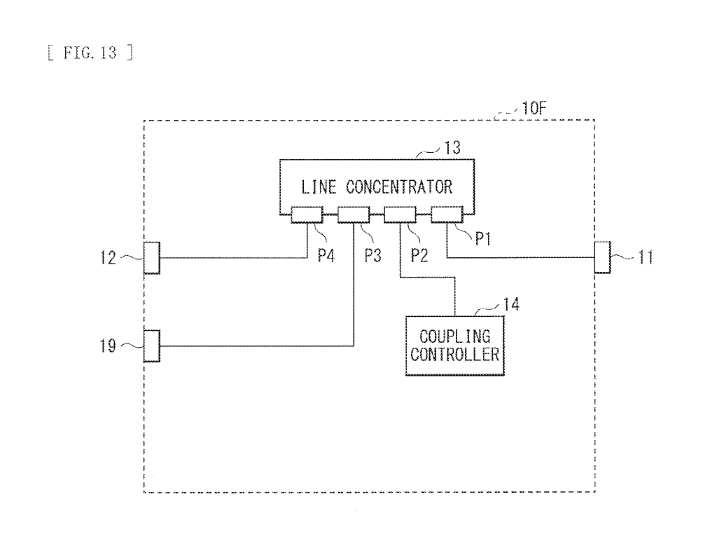

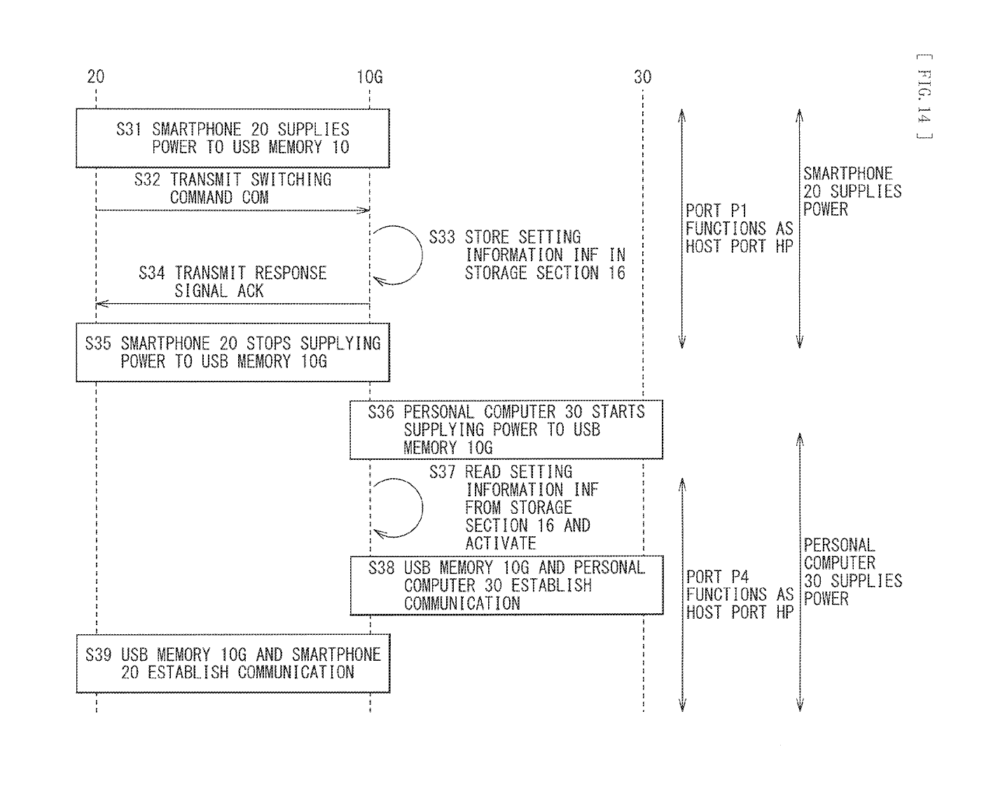

In the above-described embodiment, the technology is applied to the USB memory; however, the application is not limited thereto. For example, as illustrated in FIG. 13, the technology may be applied to a USB hub. A USB hub 10F includes a receptacle 19, the line concentrator 13, and the coupling controller 14. In the line concentrator 13, the port P1 is coupled to the plug 11, the port P2 is coupled to the coupling controller 14, the port P3 is coupled to the receptacle 19, and the port P4 is coupled to the receptacle 12.

### Modification Example 6

In the above-described embodiment, as illustrated in FIG. 7, the supply of power to the USB memory 10 is prevented from being interrupted when the host port HP is switched; however, the configuration is not limited thereto. The present modification example is described in detail below.

An electronic apparatus system 1G according to the present modification example includes a USB memory 10G. The USB memory 10G includes a coupling controller 14G.

FIG. 14 illustrates an example of a power supply operation in the electronic apparatus system 1G.

The smartphone 20 supplies power to the USB memory 10G before the user couples the personal computer 30 to the USB memory 10G (step S31). Thereafter, as illustrated in the Modification Example 2, when the user operates the smartphone 20 to make an input to the effect that the user intends to couple the personal computer 30 to the USB memory 10, the smartphone 20 transmits the switching command COM to the USB memory 10G (step S32).

Thereafter, the coupling controller 14G of the USB memory 10G generates setting information INF on the basis of the switching command COM and stores the setting information INF in the storage section 16 (step S33). The setting information INF indicates which port of the ports P1 to P4 should be set as the host port HP. In this example, the setting information INF is information indicating that the port P4 should be set as the host port HP.

Thereafter, the USB memory 10G transmits the response signal ACK to the smartphone 20 (step S34).

Thereafter, the smartphone 20 stops supplying power to the USB memory 10G (step S35). Specifically, the smartphone 20 switches the operation mode from the host mode MH to the device mode MD, on the basis of the response signal ACK. As a result, the smartphone 20 stops supplying power.

Thereafter, when the user couples the personal computer 30 to the USB memory 10G, the personal computer 30 starts supplying power to the USB memory 10G (step S36).

Thereafter, the coupling controller 14G of the USB memory 10G reads the setting information INF from the storage section 16, and activates the USB memory 10G (step S37). Thereafter, the coupling controller 14G switches the host port HP from the port P1 to the port P4 to which the personal computer 30 has been coupled.

Thereafter, the USB memory 10G and the personal computer 30 establish communication (step S38), and the USB memory 10G and the smartphone 20 establish communication (step S39).

As described above, in this example, the port P1 to which the smartphone 20 has been coupled functions as the host port HP during a period until step S35. Thereafter, the port P4 to which the personal computer 30 has been coupled functions as the host port HP during a period after step S37.

At this time, the smartphone 20 supplies power to the USB memory 10G during a period until step S35. In addition, the personal computer 30 supplies power to the USB memory 10G during a period after step S36. In other words, neither the smartphone 20 nor the personal computer 30 supplies power to the USB memory 10G during a period from step S35 to step S36. Even in such a case, it is possible for the USB memory 10G to set the host port HP by storing the setting information INF in the storage section 16 after the supply of power is restarted. In addition, unlike the case of the above-described embodiment, there is no period in which the power is supplied from both of the smartphone 20 and the personal computer 30. Thus, for example, even in a case where there is a difference between supplied voltages, it is possible for the USB memory 10G to receive power.

### Other Modification Examples

Moreover, two or more of these modification examples may be combined.

Although the technology has been described hereinbefore referring to the embodiment and the modification examples, the technology is not limited to the embodiment and the modification examples, and may be variously modified.

For example, in the above-described each embodiment, a flash memory is used as the storage section 16; however, the storage section 16 is not limited thereto, and any other device that stores data, such as a hard disk, may be used.

Further, for example, in the above-described each embodiment, the technology is applied to a USB interface; however, the application is not limited thereto, and the technology may be applied to other interfaces.

Note that the effects described herein are merely illustrative and non-limiting, and may include other effects.

Note that the present technology may have the following configurations.

(1)

An electronic apparatus, including:

a line concentrator including a plurality of ports; and

a controller that switches, among the plurality of ports, a host port to which an apparatus operating as a host is coupled, on a basis of a switching instruction supplied from a first apparatus coupled to the host port.

(2)

The electronic apparatus according to (1), in which, in a case where a second apparatus is coupled to one of the plurality of ports other than the host port, the controller notifies the first apparatus of the coupling of the second apparatus, and thereafter receives the switching instruction.

(3)

The electronic apparatus according to (2), in which the electronic apparatus receives supply of power from both of the first apparatus and the second apparatus during a first period.

(4)

The electronic apparatus according to (3), in which

the first apparatus has a plurality of operation modes that include a host mode in which the first apparatus operates as the host and a device mode in which the first apparatus operates as a device, and

the first period starts at timing at which the controller receives the switching instruction and ends at timing at which the operation mode of the first apparatus is switched from the host mode to the device mode.

(5)

The electronic apparatus according to (2), in which the electronic apparatus receives no supply of power from both of the first apparatus and the second apparatus during a second period.

(6)

The electronic apparatus according to (5), in which

the first apparatus has a plurality of operation modes that include a host mode in which the first apparatus operates as the host and a device mode in which the first apparatus operates as a device, and

the second period starts at timing at which the operation mode of the first apparatus is switched from the host mode to the device mode and ends at timing at which the second apparatus is coupled.

(7)

The electronic apparatus according to (6), further including a storage section that stores information corresponding to the switching instruction before the second period), in which

the controller switches the host port on a basis of the information stored in the storage section after the second period.

(8)

The electronic apparatus according to any one of (1) to (7), in which the controller is coupled to one of the plurality of ports.

(9)

The electronic apparatus according to any one of (1) to (7), in which the line concentrator includes the controller.

(10)

The electronic apparatus according to any one of to (9), further including a storage section.

(11)

The electronic apparatus according to (10), in which the controller further controls an operation of the storage section.

(12)

The electronic apparatus according to (10) or (11), in which the storage section stores software operated in the first apparatus.

(13)

The electronic apparatus according to (10) or (11), in which the storage section stores information that prompts acquisition of software operated in the first apparatus.

(14)

The electronic apparatus according to (12), in which

the first apparatus has a plurality of operation modes that include a host mode in which the first apparatus operates as the host and a device mode in which the first apparatus operates as a device, and

the software inquires of a user whether to operate the first apparatus in the host mode or the device mode, and generates the switching instruction on a basis of a user's operation with respect to the inquiry.

(15)

A coupling method, including:

receiving a switching instruction from a first apparatus that is coupled to a host port to which an apparatus operating as a host is coupled, among a plurality of ports of a line concentrator; and

switching the host port on a basis of the switching instruction.

This application is based upon and claims priority from Japanese Patent Application No. 2015-111087 filed with the Japan Patent Office on Jun. 1, 2015, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An electronic apparatus, comprising:
a line concentrator including a plurality of ports; and
a controller that switches, among the plurality of ports, a host port to which an apparatus operating as a host is coupled, on a basis of a switching instruction supplied from a first apparatus coupled to the host port.

2. The electronic apparatus according to claim 1, wherein, in a case where a second apparatus is coupled to one of the plurality of ports other than the host port, the controller notifies the first apparatus of the coupling of the second apparatus, and thereafter receives the switching instruction.

3. The electronic apparatus according to claim 2, wherein the electronic apparatus receives supply of power from both of the first apparatus and the second apparatus during a first period.

4. The electronic apparatus according to claim 3, wherein
the first apparatus has a plurality of operation modes that include a host mode in which the first apparatus operates as the host and a device mode in which the first apparatus operates as a device, and
the first period starts at timing at which the controller receives the switching instruction and ends at timing at which the operation mode of the first apparatus is switched from the host mode to the device mode.

5. The electronic apparatus according to claim 2, wherein the electronic apparatus receives no supply of power from both of the first apparatus and the second apparatus during a second period.

6. The electronic apparatus according to claim 5, wherein
the first apparatus hfas a plurality of operation modes that include a host mode in which the first apparatus operates as the host and a device mode in which the first apparatus operates as a device, and
the second period starts at timing at which the operation mode of the first apparatus is switched from the host mode to the device mode and ends at timing at which the second apparatus is coupled.

7. The electronic apparatus according to claim 6, further comprising a storage section that stores information corresponding to the switching instruction before the second period, wherein
the controller switches the host port on a basis of the information stored in the storage section after the second period.

8. The electronic apparatus according to claim f wherein the controller is coupled to one of the plurality of ports.

9. The electronic apparatus according to claim 1, wherein the line concentrator includes the controller.

10. The electronic apparatus according to claim 1, further comprising a storage section.

11. The electronic apparatus according to claim 10, wherein the controller further controls an operation of the storage section.

12. The electronic apparatus according to claim 10, wherein the storage section stores software operated in the first apparatus.

13. The electronic apparatus according to claim 10, wherein the storage section stores information that prompts acquisition of software operated in the first apparatus.

14. The electronic apparatus according to claim 12, wherein
the first apparatus has a plurality of operation modes that include a host mode in which the first apparatus operates as the host and a device mode in which the first apparatus operates as a device, and
the software inquires of a user whether to operate the first apparatus in the host mode or the device mode, and generates the switching instruction on a basis of a user's operation with respect to the inquiry.

15. A coupling method, comprising:
receiving a switching instruction from a first apparatus that is coupled to a host port to which all apparatus operating as a host is coupled, among a plurality of ports of a line concentrator; and
switching the host port on a basis of the switching instruction.
